(19) United States
(12) Patent Application Publication
(10) Pub. No.: US 2007/0153891 A1
(43) Pub. Date: Jul. 5, 2007

(54) Method and apparatus for smoothing overall quality of video transported over a wireless medium

(75) Inventors: Petrus Desiderius Victor Van Der Stok, Helmond (NL); Clemens Christiaan Wuest, Eindhoven (NL); Dmitri Jarnikov, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/579,156

(22) PCT Filed: Nov. 11, 2004
(86) PCT No.: PCT/IB04/52389

§ 371 Date: May 12, 2006

Related U.S. Application Data
(60) Provisional application No. 60/519,809, filed on Nov. 13, 2003.

(51) Int. Cl. H04B 1/66; H04N 7/12

(52) U.S. Cl. 375/240.1; 375/240.26

(57) ABSTRACT

A system and method for controlling a scalable video application by modeling it as a Markov decision process. The model is based on measuring the relative progress of the application, where relative progress is the difference between the allocated CPU budget for processing a frame and the actual CPU cycles used in processing a frame. The control strategy is based on the number of levels most recently decoded and the maximum levels that can be decoded for the next frame based on the number of received layers (the maximum quality level) and the budgeted CPU time. The object is to smooth quality transitions between frames by developing a quality level control strategy that minimizes both the number of deadline misses (frame not fully decoded) and the number of quality level changes, while maximizing the quality level. The fewer the number of quality level changes, the smoother the image viewed.

The present invention relates to methods for a scalable video application to control the decoding quality of video frames transported over a wireless medium to smooth overall quality.

The bandwidth fluctuations of wireless media (e.g., IEEE 802.11) are generally very large. To enable a reasonable viewing experience of a video transported over a wireless medium, the code is sent over as a Base Layer (BL) and one or more Enhancement Layers (EL) (e.g., MPEG4 or MPEG2 scalable profiles). This technique is called scalable video streams. The concept of scalable video proposes partitioning video data into BL and ELs in such a way, that the transmission and decoding of the BL is enough to reconstruct video of recognizable quality, while the transmission and processing of ELs is needed only for additional improvement of the quality of the received video sequence. For example: A BL with one EL delivers reasonable quality images, while the BL with all ELs delivers maximum quality video images. The BL is first sent over the network for each frame, followed by the consecutive EL parts belonging to that frame.

When the bandwidth fluctuates considerably, only the BL arrives for one frame while for other frames the BL with one or more ELs arrive at the display. This results in constantly changing image quality. Such changes in quality are not appreciated by an end-user who is viewing the received images.

The present invention provides a system and method for controlling the overall output quality of a media processing application that can process media frames, e.g., video frames, at a plurality of quality levels. A quality level corresponds to the processing of the BL and a particular number of ELs (zero or more). Each quality level requires a distinguishable (but, not necessarily fixed) amount of resources, e.g., CPU. A higher quality level (i.e., a bigger number of ELs that are processed) results in better quality image, at cost of a higher resource usage. The quality level is chosen on a per-frame basis. Since resources are finite, processing may not be completed for a given level of output quality by the deadline for the completion of this output processing, i.e., a deadline miss occurs. Each deadline miss results in severe artifacts in the output. Due to the wireless media nature, the number of layers received for a given frame varies over time, which restricts the number of quality levels that can be chosen for the frame. In a preferred embodiment, every time a media frame is received, e.g., a video frame, and must be displayed, the number of received layers is inspected. The maximum number of layers that can be processed is determined by the number of received layers for a frame and the time that the CPU is available to process the layers of that frame with minimal risk of missing the corresponding deadline. However, quality level changes may result in perceivable artifacts. By minimizing the number of quality level jumps over time, i.e., smoothing the received images over time, the user views an image having a fairly stable quality. This smoothing is done, in a preferred embodiment, by setting up a Markov chain and defining a value function. Quality level changes that are not caused by the network conditions yield much negative value. Quality level changes that are caused by network fluctuations yield zero value in the case of quality drop. Showing no image at all receives the highest penalty. On the other hand, a higher number of processed layers yields a higher value.

By playing many videos with realistic packet losses a layer selection procedure has been developed that is optimized with respect to the value function. The optimized layer selection function developed in this manner, is used to determine the number of layers that need to be displayed as a fumction of the number of received layers for a given frame and for the preceding frames.

There are a number of approaches that deal with optimizing resource consumption and maximizing output quality. One is the approach of the present invention to apply scalable video algorithms to the decoding of scalable video. A quality level is defmed as a number of layers to be processed. Prior art algorithms assume a stable input (like DVD). Stable input means that there is no loss of information during transmission, thus it implies that during decoding of the video data any quality level can be chosen. The present invention deals with unstable input as well. It optimizes decoding (and possibly, post-processing) strategy by looking not only at CPU availability but also at the input of the application. Basically, the present invention introduces dependency from the network into the controlling strategy. Thus, the present invention can work with stable (e.g. CD, DVD, HDD) and unstable (wireless network) inputs.

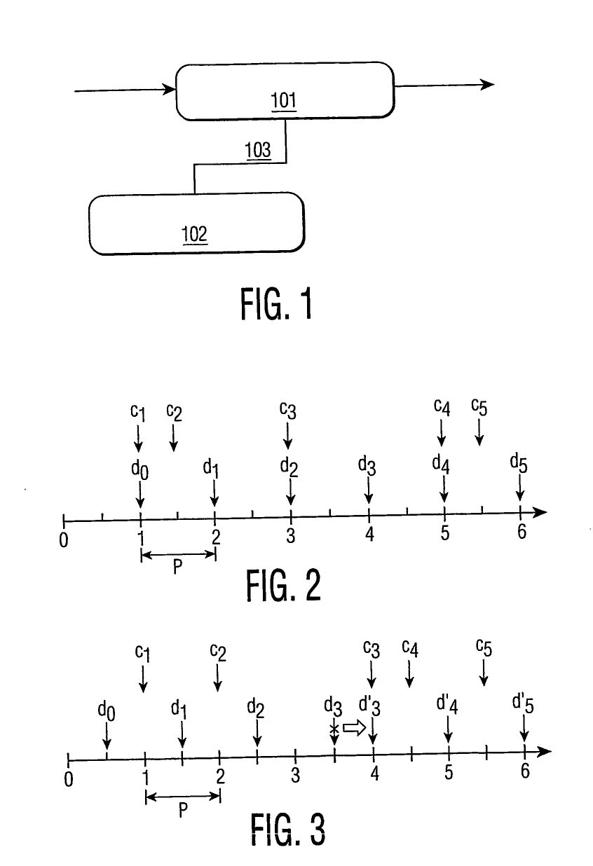

FIG. 1 illustrates a general view of a scalable video application.

FIG. 2 illustrates an example tirneline of a scalable video application according to an embodiment of the present invention.

FIG. 3 illustrates and example timeline in which a deadline (d₃) is missed.

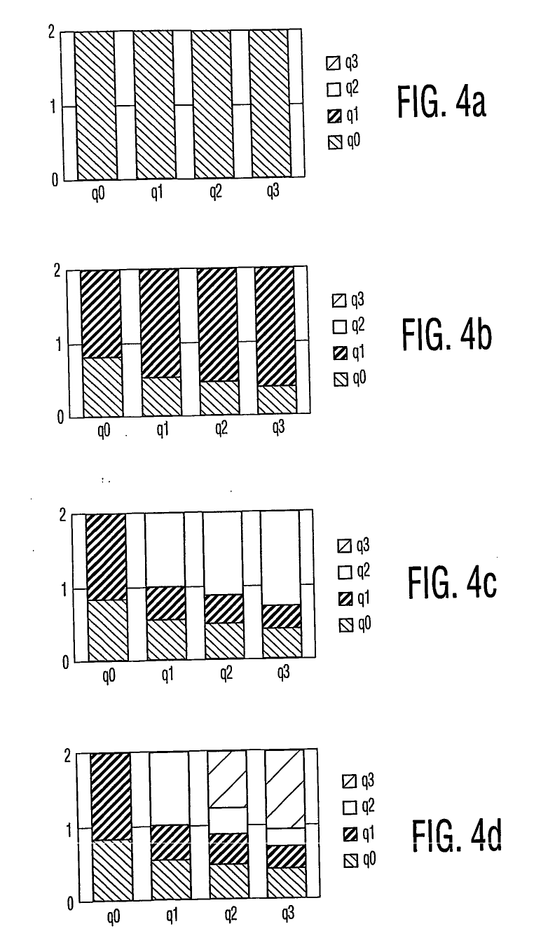

FIG. 4 illustrates relative progress v. previously used quality level for q0, q1, q2, and q3 for an optimal strategy according to the present invention where b=40000 and |Π|=300.

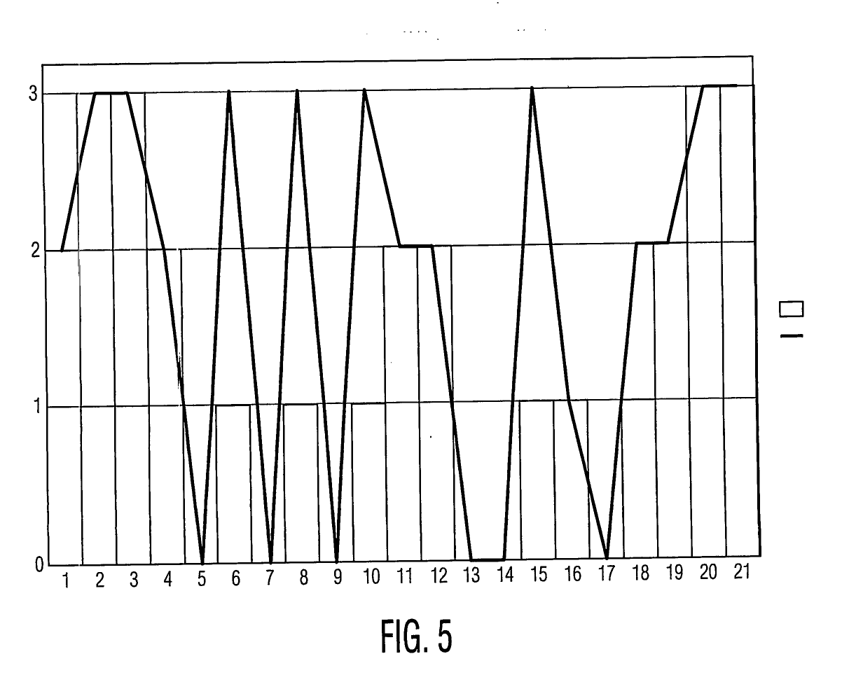

FIG. 5 illustrates behavior of a scalable application according to the present invention.

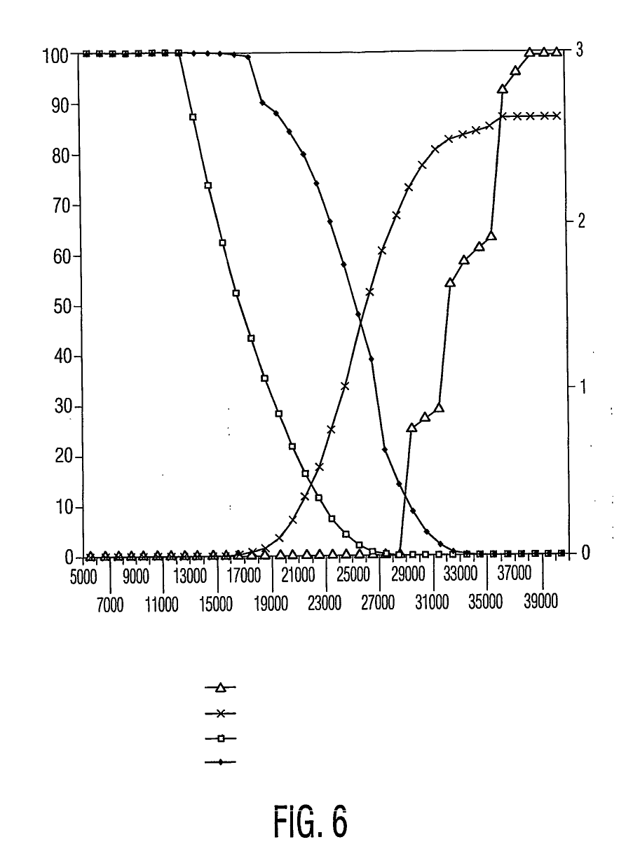

FIG. 6 illustrates a qualitative comparison of a scalable video application according to the present invention with a straightforward application.

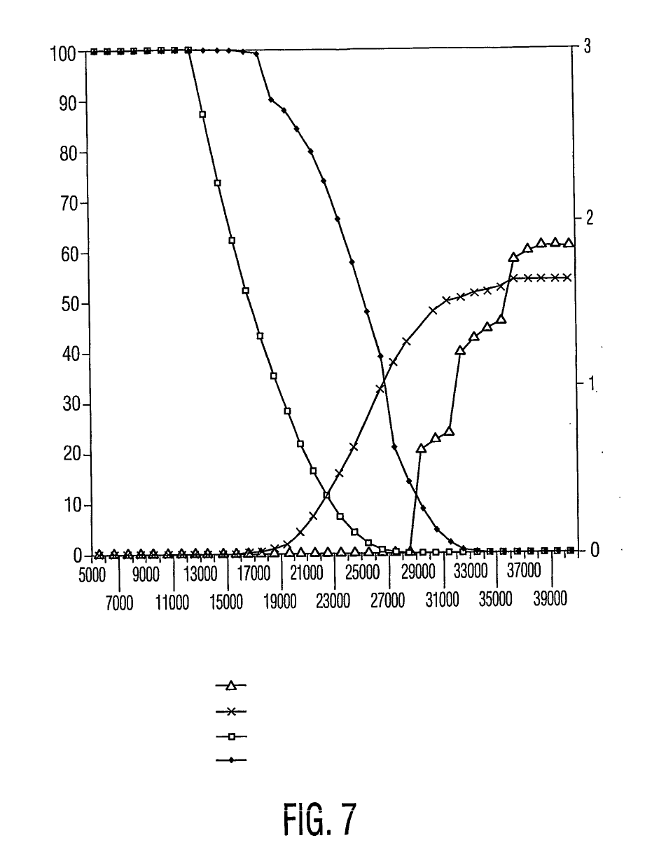

FIG. 7 illustrates a qualitative comparison of a scalable video application according to the present invention for 1000 changes of maximum quality level.

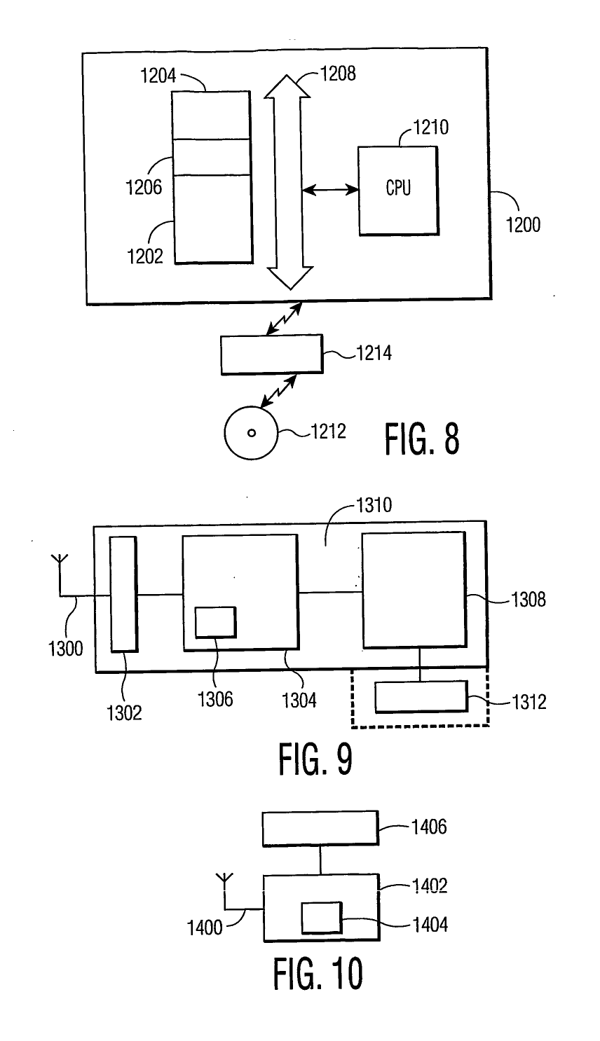

FIG. 8 illustrates a simplified block diagram illustrating the architecture of a system according to an embodiment of the present invention.

FIG. 9 illustrates a TV set modified according to the present invention.

FIG. 10 illustrates a set-top box modified according to the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

The present invention provides a system and method for a video control mechanism for controlling a scalable video application that allows dynamic change of the internal setting for resolving a trade-off between resource usage and output quality. FIG. 1 illustrates the basic concept of a scalable video processor with a control mechanism 102 influencing the behavior of a scalable application 101 by means of a set of parameters 103. The use of scalable applications to accomplish video processing allows parts of the application to be readily scaled so that output qualities can be achieved thereby enabling resource consumption to be balanced against output quality.

Consider a video decoder as a scalable video application (SVA). This video decoder can be controlled by varying its internal settings to produce an output video stream of variable quality. As illustrated in Table 1, the decoder processes only the base layer when it operates at the lowest quality level. With the increase of the quality level, the decoder increases the number of layers to be processed, as well as the processing time (and, obviously the resource consumption).

TABLE 1

| Quality level | Number Of Layers To Be Processed |
|---|---|
| q₀ | BL |
| q₁ | BL + EL₁ |
| q₂ | BL + EL₁ + EL₂ |
| . . . | . . . |
| qₙ | BL + EL₁ + EL₂ + . . . + EL_{N} |

However, not all the layers are always available. Given that the decoder receives the layers from a network, there is no guarantee for the number of layers input to the decoder at any moment in time. Therefore, it is uncertain what number of layers will be processed next. Information about the number of available layers can be obtained from the input buffer.

In general the processing by the scalable application of the present invention is described as follows. The application fetches a unit of work (frame) from an input buffer, processes it and puts the result into an output buffer. The application periodically receives a fixed budget of CPU time for processing a unit of work, i.e., a video frame. Units of work differ in size and complexity, which results in a difference in the time that is required for processing a unit of work. The completion of a unit of work is termed a milestone and for each such milestone there is a deadline. In the context of a scalable video application, the decoding of a frame is a unit of work having strictly periodical deadlines, i.e., deadlines occur with a given and fixed periodicity P. Deadline misses are to be prevented.

At each milestone, the relative progress is calculated as the amount of guaranteed resource budget remaining until the deadline of the milestone, expressed in deadline periods. Since buffer size is finite, there is an upper limit on the number of frames it may contain. This renumber of frames can he used to provide a range for the number of frames that can be decoded in advance as
{min[number of frames in input buffer], max[number of frames in output buffer]}
If the relative progress at a milestone turns out to be negative, at least one deadline has been missed, i.e., it would have taken more than the guaranteed budget to process at least one frame so that the relative progress was negative. The effect of such deadline misses is cumulative, when no measures are taken. In order to prevent such cumulative deadline misses, the application adapts the quality level at which it runs at each milestone.

Three objectives are adopted for choosing the quality level:
1. quality level is maximized;
2. deadline misses are minimized; and
3. quality level changes are minimized.
   Post processing is not taken into consideration by the application of the present invention.

Restating these objectives, a quality level control strategy is needed for a scalable media processing application, which has been allocated a fixed CPU budget such that it minimizes both the number of deadline misses and the number of quality level changes, while maximizing the quality level.

According to the invention, this problem is modeled as a Markov decision problem. The model is based on calculating relative progress of an application at its milestones. Solving the Markov decision problem results in a quality level control strategy that can be applied during run time while incurring little overhead.

Consumer terminals, such as set-top boxes and digital TV-sets, are required by the market to become open and flexible. This is achieved by replacing several dedicated hardware components, performing specific media processing applications, by a central processing unit (CPU) on which equivalent media processing applications execute. Resources, such as CPU time, memory, and bus bandwidth, are shared between these applications. Here, preferably only the CPU resource is considered.

At each milestone, the relative progress of the application is calculated. Here, the relative progress at a milestone is defined as the time until the deadline of the milestone, expressed in deadline periods.

Relative progress at milestones can be calculated as follows. Assume, without loss of generality, that the application starts processing at time t=0. The time of milestone m is denoted by cₘ. Next, the deadline of milestone m is denoted by dₘ. The deadlines are strictly periodic, which means that they can be written as
dₘ=d₀+m*P
where P is the period between two successive deadlines and d₀ is an offset. The relative progress at milestone m, denoted by ρₘ, is now given by

$${ρ}_{m} = \frac{{d}_{m} - {c}_{m}}{P} = m - \frac{{c}_{m} {d}_{0}}{P} \qquad ( 1 )$$

To illustrate the calculation of relative progress, consider the example timeline shown in FIG. 2. In this example, P=1 and d₀=1. The relative progress at milestones 1 up to 5, calculated using (1), is given by ρ₁=(d₁−c₁)/P=(2−1)/1=1, ρ₂=1.5, ρ₃=1, ρ₄=0, and ρ₅=0.5. Note that milestone 4 is just in time.

If the relative progress at a milestone (m+1)^{th} drops below zero, then ┌−ρₘ₊₁┐ (the next larger integer to −ρₘ₊₁) deadline misses have occurred since the m^{th} milestone. How deadline misses are dealt with, is application specific. Here, a work preserving approach is assumed, meaning that the just created output is not thrown away, but is used anyhow. One way would be to use this output at the first next deadline, which means that an adapted relative progress
ρ′ₘρₘ+┌−ρₘ┐≧0

is obtained. A conservative approach is assumed by choosing ρ′ₘ=0, i.e., the lowest possible value, which in a sense corresponds to using the output immediately upon creation.

In other words, the deadline dₘ and subsequent ones are postponed an amount of −ρₘ*P.

Consequently, the relative progress at milestones using (1) can be calculated, however with a new offset d′₀=d₀−ρₘ*P.

This process is illustrated by means of the example timeline shown in FIG. 3. In this example, P=1 and d₀=0.5. Using (1), the following can be derived:ρ₁=0.5, ρ₂=0.5, and ρ₃=−0.5. The relative progress at milestone 3 has dropped below zero, so ┌−ρ₃┐=1 deadline miss has occurred since milestone 2, viz. at t=3.5. Next, deadline d₃ is postponed to d′₃=c₃=4, and further deadlines are also postponed by an amount of 0.5. Continuing, ρ₄=0.5, and ρ₅=0.5 are found.

The state of the application at a milestone is given by its relative progress. This, however, gives an infinitely large set of states, whereas a Markov decision process requires a finite set. The latter is accomplished as follows: let p>0 denote the given upper bound on relative progress. The number p is a measure of the number of periods that the application can work ahead, which is derived from the buffer sizes as explained above. The relative progress space between 0 and p is divided into a finite set
Π={π₀, . . . , πₙ₋₁}of n≧1
progress intervals

$${π}_{k} = [ \frac{kp}{n} , \frac{( k + 1 ) p}{n} ) , for k = 0 , … , n - 1.$$

The lower bound and the upper bound of a progress interval π is denoted by π and π̅, respectively.

At each milestone, a decision must be taken about the quality level at which the next unit of work will be processed. Hence, the set of decisions that can be taken in a state, i.e., in the Markov decision problem, corresponds to the set of quality levels at which the application can run. This set is denoted by Q.

Every quality level corresponds to the number of layers that are processed. Therefore, it is not possible to choose the quality level which requires decoding more layers than there are in the input buffer for a given frame. Thus the maximal quality level that can be chosen is given by the number of layers received and is defined by maxq(i).

Quality level changes are also taken into account, thus at each milestone the previously used quality level must be known. This can be realized by extending the set of states with quality levels. Therefore, a state i is defined by
the relative progress interval in state i, denoted by π(i);
the maximal quality level that it is possible to choose for the next unit of work in state i, denoted by maxq(i);
the previously used quality level in state i denoted by q(i). Therefore, the set of states becomes Π×Q×Q.

A second element of which Markov decision problems consist is a set of transition probabilities. Let pᵢⱼ^{q} denote the transition probability for making a transition from a state i at the current milestone to a state j at the next milestone, if quality level q is chosen to process the next unit of work. After the transition, q(j)=q and maxq(i)≧q, which means that pᵢⱼ^{q}=0 if q≠q (j) or q>maxq(i).

Assume, without loss of generality, that the application is in state i at milestone m. For each quality level q, we introduce a random variable X_{q}, which gives the time that the application requires to process one unit of work in quality level q. If it is assumed that, the application receives a computation budget b per period P, then the relative progress ρₘ₊₁ can be expressed in ρₘ by means of the recursive equation

$${ρ}_{m + 1} = ( {ρ}_{m} + 1 - \frac{{X}_{q}}{b} ) {\vert}_{[ 0 , p ]} , \qquad ( 2 )$$

where the notation is used:

$$x {\vert}_{[ 0 , p ]} = \{ \begin{matrix}0 if x < 0 \\ x if 0 \leq x \leq p \\ p if x > p .\end{matrix}$$

Let Y_{π,ρ}_{ₘ}_{,q,maxq}_{ₘ}_{,maxq}_{ₘ₊₁} be a random variable, which gives the probability that the relative progress ρₘ₊₁ of the application at the next milestone, m+1, is in progress interval π and the maximal quality level that can be chosen in this milestone is maxqₘ₊₁, provided that the relative progress at the current milestone is ρₘ, the maximal quality level is maxqₘ₊₁ and quality level q is chosen.

The variable Y_{π,ρ}_{ₘ}_{,q,maxq}_{ₘ}_{,maxq}_{ₘ₊₁} describes the probability of two independent events—the application in the next milestone is in the progress interval π and the maximal quality level maxqₘ is set to maxqₘ₊₁. Therefore,
Y_{π,ρ}_{ₘ}_{,q,maxq}_{ₘ}_{,maxq}_{ₘ₊₁}=Y_{maxq}_{ₘ}_{,maxq}_{ₘ₊₁}*Y_{π,ρ}_{ₘ}_{,q}′

Then it is derived:

$${Y}_{π , {ρ}_{m} , q} = \{ \begin{matrix}P ( {ρ}_{m + 1} < \overline{π} ) = 1 - P ( {ρ}_{m + 1} \geq \overline{π} ) & if π = {π}_{0} \\ P ( {ρ}_{m + 1} \geq \underline{π} ) & if π = {π}_{n - 1} \\ P ( \underline{π} \leq {ρ}_{m + 1} < \overline{π} ) = P ( {ρ}_{m + 1} \geq \underline{π} ) - P ( {ρ}_{m + 1} \geq \overline{π} ) & otherwise .\end{matrix}$$

Let F_{q} denote the cumulative distribution function of X_{q} and make a pessimistic approximation of ρₘ by choosing the lowest value in the interval
\tilde{ρ}ₘ=π(i) (3)
Given the above, the probabilities pᵢⱼ^{q} can be approximated by

$${\tilde{p}}_{ij}^{q} = \{ \begin{matrix}{Y}_{max {q}_{m} , max {q}_{m + 1}} * ( 1 - {F}_{q} ( b ( 1 - \overline{π} ( j ) + \underline{π} ( i ) ) ) ) & if π ( j ) = {π}_{0} \\ {Y}_{max {q}_{m} , max {q}_{m + 1}} * {F}_{q} ( b ( 1 - \underline{π} ( j ) + \underline{π} ( i ) ) ) & if π ( j ) = {π}_{n - 1} \\ \begin{matrix}{Y}_{max {q}_{m} , {max}_{m + 1}} * {F}_{q} ( b ( 1 - \underline{π} ( j ) + \underline{π} ( i ) ) ) - \\ {F}_{q} ( b ( 1 - \overline{π} ( j ) + \underline{π} ( i ) ) )\end{matrix} & otherwise .\end{matrix}$$

The more progress intervals are chosen, the more accurate the modeling of the transition probabilities is, as the approximation in (3) is better.

A third element of which Markov decision problems consist is revenues. The revenue for choosing quality level q in state i is denoted by rᵢ^{q}. Revenues are used to implement the three problem objectives.

First, the quality level at which the units of work are processed should be as high as possible. This is realized by assigning a reward to each rᵢ^{q}, which is given by a function u(q). This function is referred to as the utility function. It returns a positive value, directly related to the perceived quality of the output of the application running at quality level q.

Secondly, the number of deadline misses should be as low as possible. The deadline miss penalty function returns a positive value that is related to the number of deadlines we expect to miss, if the quality level q is chosen in the current state. This value should be subtracted from the revenue. Finally, the number of quality level changes should be as low as possible. This is accomplished by subtracting a penalty, given by a function c(q(i),q), from each rᵢ^{q}. This function returns a positive value, which may increase with the size of the gap between q(i) and q, if q(i)≠q, and 0 otherwise. Furthermore, an increase in quality level may be given a lower penalty than a decrease in quality level. The function c(q(i),q) is referred to as the quality change function.

If only a finite number of transitions is considered (a so-called finite time horizon), the solution of a Markov decision problem is given by a decision strategy that maximizes the sum of the revenues over all transitions, which can be found by means of dynamic programming. However, there is an infinite time horizon, because the number of transitions cannot be limited. In that case, a useful criterion to maximize is given by the average revenue per transition. This criterion emphasizes that all transitions are equally important. There are a number of solution techniques for the infinite time horizon Markov decision problem, such as successive approximation, policy iteration, and linear programming. See for example Martin L. Puterman, Markov Decision Processes: Discrete Stochastic Dynamic Programming, Wiley Series in Probability and Mathematical Statistics, John Wiley & Sons Inc. 1994 and D. J. White, Markov Decision Processes, John Wiley & Sons Inc. 1993. For the experiments described here, successive approximation is used.

Solving the Markov decision problem results in an optimal stationary strategy. Stationary here means that the applied decision strategy is identical at all milestones, i.e. it does not depend on the number of the milestone. An example control strategy, for
|Π|=300, b=40000 μs
is shown in FIG. 4. This FIG. illustrates that, for example, if the relative progress at a particular milestone is equal to 1, and if the previously used quality level is q₃ and the maximum quality level for the next frame is q₃, then quality level q₃ should be chosen to process the next unit of work, i.e., the next frame.

Without loss of optimality, so-called monotonic control strategies can be used, i.e., per previously used quality level it can be assumed that a higher relative progress results in a higher or equal quality level choice. Then, for storing an optimal control strategy, per previously used quality level only the relative progress bounds at which the control strategy changes from a particular quality level to another one have to be stored. A control strategy therefore has a space complexity of O(|Q|²), which is independent of the number of progress intervals.

The Markov decision problem can be solved off-line, before the application starts executing. Next, we apply the resulting control strategy on-line, as follows. At each milestone, the previously used quality and the maximum quality levels are known, and the relative progress of the application is calculated. Then, the quality level at which the next unit of work is to be processed is looked up. This approach incurs little overhead.

As input for the experiments an MPEG-2 Signal to Noise Ratio (SNR) decoding trace file of a video sequence consisting of 120000 frames is used. This trace file contains for each frame the processing time required to decode it, expressed in CPU cycles on a TriMedia, in each of four different quality levels, labeled q₀ up to q₃ in increasing quality level order. That is, the number of enhancement layers was set to 3 and the bit-rate for all layers is equal.

As a first step in the evaluation of the present invention, an assumption was made that the probabilities of transition from one maximal quality level to another are equal. Therefore, at milestone m the variable
Y_{maxq}_{ₘ}_{,maxq}_{ₘ₊₁} has the same value for any pair maxqₘ and maxqₘ₊₁.

Secondly, the problem parameters are defmed as follows. The upper bound on relative progress p is chosen equal to 2, which assumes that an output buffer is used that can store at least two decoded frames. It also assumes that the input buffer contains at least two frames at any moment of time.

The perceptive quality of the video depends on the actual bit-rate of the video stream, which is directly connected to the quality levels. Given the quality factor is increased by a factor of 2 with every quality level increase a utility function is defined by
u(q₀)=2 u(q₁)=4 u(q₂)=7.5 u(q₃)=12.

The deadline miss penalty is chosen equal to 100000, which means that roughly about 1 deadline miss per 8000 frames is allowed. In other words, at most 1 frame is skipped per 5 minutes of video.

The quality level change penalties for increasing the quality level are set to 5, 50 and 500 if the quality level is increased by 1, 2, and 3, respectively. For decreasing the quality, level the penalties are set to 50, 500, and 5000 for going down by 1, 2, and 3 levels, respectively. If the quality level is decreased from q(i) to q(j) because the maximum quality level for the state j is equal to q(j), given the number of available layers in state j, this is considered a forced change and the quality level change penalty is set to zero.

An evaluation was done that compared the present invention to a straightforward algorithm in which as many layers as possible are decoded within the given CPU budget. As mentioned, successive approximation is used to solve the problem instances. Apart from calculation inaccuracy, successive approximation finds optimal control strategies. A value of 0.001 was used for the inaccuracy tolerance. The resulting control strategies give at each milestone the quality level at which the next frame should be decoded, given the relative progress, tne previously used quality level, and the maximum quality level.

i. Test 1

The first test used a budget of 40 ms and maximum quality level, assuming that network throughput is sufficient for delivery of all layers. Table 2 contains the changes in quality levels for the scalable application of the present invention. Table 3 contains the changes in quality levels for the straightforward application. As shown in Table 2 and Table 3, the straightforward algorithm makes a change in the quality level on average every 4^{th} frame, which is 1300 times the number of changes made by the present invention. At the same time, the average quality for the scalable application of the present invention is higher than for the straightforward application, as illustrated in Table 4, which illustrates the percentage of quality level usage.

TABLE 2
Changes of Quality Levels for the Scalable Application in Test 1

| | To | To | To | To | |
|---|---|---|---|---|---|
| | q₀ | q₁ | q₂ | q₃ | Total |
| From | — | 1 | 0 | 0 | 1 |
| q₀ | | | | | |
| From | 0 | — | 5 | 0 | 5 |
| q₁ | | | | | |
| From | 0 | 1 | — | 11 | 12 |
| q₂ | | | | | |
| From | 0 | 2 | 4 | — | 6 |
| q₃ | | | | | |
| | | | | | 24 |

TABLE 3
Changes of Quality Levels for the Straightforward
Application in Test 1

| | To | To | To | To | |
|---|---|---|---|---|---|
| | q₀ | q₁ | q₂ | q₃ | Total |
| From | — | 4 | 0 | 9908 | 9912 |
| q₀ | | | | | |
| From | 38 | — | 0 | 5235 | 5273 |
| q₁ | | | | | |
| From | 0 | 0 | — | 0 | 0 |
| q₂ | | | | | |
| From | 16900 | 4327 | 0 | — | 21137 |
| q₃ | | | | | |
| | | | | | 36322 |

TABLE 4
Percentage of Quality Level Usage in Test 1

| | q₀ | q₁ | q₂ | q₃ |
|---|---|---|---|---|
| Scalable Video | 0.00122 | 0.00549 | 0.02256 | 99.97074 |
| Straightforward | 9.77427 | 4.36532 | 0 | 85.86041 |

ii. Test 2

For the second test the budget is 40 ms and the maximal quality level that can be chosen for processing a frame (i.e., the number of layers for a frame that are available in the buffer) is generated randomly. As shown in Tables 5 -7, in the second test (when the number of maximum quality level changes is 1228) some of the changes made by the scalable application of the present invention are caused by attempts to smooth frequently occurring transitions from one level to another, which is illustrated in FIG. 5.

TABLE 5
Changes of Quality Levels for the Scalable Application in Test 2

| | To | To | To | To | |
|---|---|---|---|---|---|
| | q₀ | q₁ | q₂ | q₃ | Total |
| From | — | 259 | 0 | 0 | 259 |
| q₀ | | | | | |
| From | 34 | — | 321 | 0 | 355 |
| q₁ | | | | | |
| From | 47 | 57 | — | 408 | 512 |
| q₂ | | | | | |
| From | 100 | 129 | 129 | — | 358 |
| q₃ | | | | | |
| | | | | | 1484 |

TABLE 6
Changes of Quality Levels for the Straightforward
Application in Test 2

| | To | To | To | To | |
|---|---|---|---|---|---|
| | q₀ | q₁ | q₂ | q₃ | Total |
| From | — | 2781 | 2304 | 5845 | 10930 |
| q₀ | | | | | |
| From | 2780 | — | 1500 | 1993 | 6273 |
| q₁ | | | | | |
| From | 2659 | 1205 | — | 44 | 3908 |
| q₂ | | | | | |
| From | 6219 | 2056 | 25 | — | 8300 |
| q₃ | | | | | |
| | | | | | 29411 |

TABLE 7
Percentage of Quality Level Usage in Test 2

| | q₀ | q₁ | q₂ | q₃ |
|---|---|---|---|---|
| Scalable Video | 23.60235 | 24.87458 | 25.52075 | 26.00233 |
| Straightforward | 30.64737 | 24.74039 | 22.10327 | 22.50896 |

iii. Comparison

Both applications incur deadline misses. FIG. 6 illustrates the percentage of deadline misses and average quality level for both applications for varying budgets and fixed maximum quality level. The straightforward application easily moves between different quality levels while remaining within the given CPU budget. Therefore, under low CPU budget conditions, the average quality for the straightforward application is considerably higher than that of the present invention. However, the penalty for needless increases in quality level is a huge number of deadline misses. The scalable video application of a preferred embodiment of the present invention permits a quality level increase only after it can guarantee that the number of deadline misses for the given CPU budget lies within the predefined limit of 1 per 8000 frames.

FIG. 7 shows the result for the case when the maximum quality level is chosen randomly. As can be seen from FIG. 7, when the maximum quality level changes frequently, the straightforward application has, on average, higher quality level than the scalable application of the present invention. This is the caused by the fact that the scalable application makes quality level jumps smoother, which results in the slower growth of the quality level after it is forced down.

Quality level control for scalable media processing applications having fixed CPU budgets was modeled as a Markov decision problem. The model was based on relative progress of the application, calculated at milestones and amount of available video data (e.g. received layers) in the input buffer of the application. Three objectives were adopted for choosing the quality level:
1. quality level is maximized;
2. deadline misses are minimized; and
3. quality level changes are minimized, taking into account the maximum quality level determined by the number of received layers. Post processing was not taken into consideration.

Restating these objectives, a quality level control strategy was developed for a scalable media processing application, which had been allocated a fixed CPU budget such that it minimized both the number of deadline misses and the number of quality level changes, while maximizing the quality level. A parameter in the model is the number of quality level changes. the fewer the number of changes the smoother the image viewed.

FIG. 8 illustrates a system 1200 according to the invention in a schematic way. The system 1200 comprises memory 1202 that communicates with the central processing unit 1210 via software bus 1208. Memory 1202 comprises computer readable code 1204 designed to determine the amount of CPU cycles to be used for processing a media frame as previously described. Further, memory 1202 comprises computer readable code 1206 designed to control the quality level of the media frame based on relative progress of the media processing application calculated at a milestone. Preferably, the quality level of processing the media frame is set based upon a Markov decision problem that is modeled for processing a number of media frames as previously described. The computer readable code can be updated from a storage device 1212 that comprises a computer program product designed to perform the method according to the invention. The storage device is read by a suitable reading device, for example a CD reader 1214 that is connected to the system 1200. The system can be realized in both hardware and software or any other standard architecture able to operate software.

FIG. 9 illustrates a television set 1310 according to the invention in a schematic way that comprises an embodiment of the system according to the invention. Here, an antenna, 1300 receives a television signal. Any device able to receive or reproduce a television signal like, for example, a satellite dish, cable, storage device, internet, or Ethernet can also replace the antenna 1300. A receiver, 1302 receives the television signal. Besides the receiver 1302, the television set contains a programmable component, 1304, for example a programmable integrated circuit. This programmable component contains a system according to the invention 1306. A television screen 1308 shows the document that is received by the receiver 1302 and is processed by the programmable component 1304. The television set 1310 can, optionally, comprise or be connected to a DVD player 1312 that provides the television signal.

FIG. 10 illustrates, in a schematic way, the most important parts of a set-top box 1402 that comprises an embodiment of the system according to the invention. Here, an antenna 1400 receives a television signal. The antenna may also be for example a satellite dish, cable, storage device, internet, Ethernet or any other device able to receive a television signal. A set-top box 1402, receives the signal. The signal may be for example digital. Besides the usual parts that are contained in a set-top box, but are not shown here, the set-top box contains a system according to the invention 1404. The television signal is shown on a television set 1406 that is connected to the set-top box 1402.

It should be noted that the above-mentioned embodiments illustrate rather than limit the invention, and that those skilled in the art will be able to design many alternative embodiments without departing from the scope of the appended claims. The invention can be implemented by means of hardware comprising several. distinct elements, and by means of a suitably programmed computer. In addition, many modifications may be made to adapt to a particular situation and the teaching of the present invention can be adapted in ways that are equivalent without departing from its central scope. Therefore it is intended that the present invention not be limited to the particular embodiment disclosed as the best mode contemplated for carrying out the present invention, but that the present invention include all embodiments falling within the scope of the appended claims.

1. A method of setting a quality level of an output image of a media frame by a media processing application, comprising the steps of:
determining an amount of resources to be used for processing the media frame;
controlling the quality level of the output image based on
i. relative progress of the media processing application calculated at a milestone,
ii. a maximal quality level that is possible to choose for the output image,
iii. a previously used quality level of an output image, and
iv. a maximum quality level based on the number of received layers

2. The method of claim 1, wherein the quality level is chosen based on a minimum of the highest quality level possible for processing the next frame and a highest quality level required to maintain the quality of the output image.

3. The method of claim 1, wherein:
the step of controlling the quality level of the media frame is modeled as a Markov decision problem comprising a set of states, a set of decisions, a set of transition probabilities and a set of revenues;
solving the Markov decision problem to derive an optimal strategy; and
determining the number of layers of the media frame that are decoded based upon this solution.

4. The method of claim 3, further comprising the steps of:
defining the set of states to comprise the relative progress of the media processing application at a milestone and the previously used quality level;
defining the set of decisions to comprise a plurality of quality levels that the media processing application can provide;
defining the set of transition probabilities to comprise a probability that a transition is made from a state of the set of states at a current milestone to an other state of the set of states at a next milestone for a given quality level of the plurality of quality levels; and
defining the set of revenues to comprise a positive revenue related to a quality level of the media frame, a negative revenue related to a deadline miss and a negative revenue related to a quality level change.

5. A system to set a quality level of an output image of a media frame by a scalable media processing application, the system comprising:
determining means to determine an amount of resources to be used for processing the media frame;
controlling means to control the quality level of the output image of the media frame based on
i. relative progress of the media processing application calculated at a milestone,
ii. a maximal quality level that is possible to choose for the output image of the media frame, and
iii. a previously used quality level of an output image of a media frame, and,
iv. a maximum quality level based on the number of received layers.

6. The system of claim 5, wherein the quality level chosen is further based on a minimum of the highest quality level possible for processing the next frame and a highest quality level required to maintain the quality of the output image.

7. The system of claim 5, wherein, the controlling means is further configured to:
model the control of the quality level of the media frame as a Markov decision problem comprising a set of states, a set of decisions, a set of transition probabilities and a set of revenues;
be a solution to the Markov decision problem using a decision strategy; and
set the quality level of the media d upon this solution.

8. The system of claim 7, wherein:
the set of states comprises the relative progress of the media processing application at a milestone and a previously used quality level of a previous media frame;
the set of decisions comprises a plurality of quality levels that the scalable media processing application can provide;
the set of transition probabilities comprises a probability that a transition is made from a state of the set of states at a current milestone to another state of the set of states at a next milestone for a given quality level of the plurality of qualities; and
the set of revenues comprises a positive revenue related to a positive quality level of the media frame, a negative revenue related to a deadline miss and a negative revenue related to a quality level change.

9. A computer program product designed to perform the method according to claim 1.

10. A storage device comprising a computer program product according to claim 9.

11. A television set comprising a system according claim 5.

12. A set-top box comprising a system according claim 5.
